(19) United States
(12) Patent Application Publication
(10) Pub. No.: US 2011/0064533 A1
(43) Pub. Date: Mar. 17, 2011

(54) Drilling Machine Tool

(75) Inventors: Kurt BATTENFELD, Ebsdorfergrund/Wittelsberg (DE); Thomas GLOCKSEISEN, Dusseldorf (DE)

(73) Assignee: WEZAG GMBH WERKZEUGFABRIK, Stadtallendorf (DE)

(21) Appl. No.: 12/881,404

(22) Filed: Sep. 14, 2010

(30) Foreign Application Priority Data
Sep. 15, 2009 (DE) 10 2009 041 337.5

(51) Int. Cl. B23D 79/12; B23B 51/00

(52) U.S. Cl. 408/147; 408/204

(57) ABSTRACT

The invention relates to a tool for at least partially removing a coating or layer of a base body of a tube.

The inventive drilling machine tool comprises a base body. At least one guiding element aligns the base body with the tube and defines a rotational axis for a rotational movement of the base body around the tube. A blade is linked with the base body with a degree of freedom in a direction radial to the rotational axis. The blade has a cutting edge which has an orientation parallel to the rotational axis. An activation element biases the blade in radial inner direction. When driven by a drilling machine, the drilling machine tool rotates around the tube located within the drilling machine tool, wherein the blade “peels” the coating or layer from the tube.

### CROSS REFERENCE TO RELATED APPLICATIONS

This application claims priority to co-pending German Patent Application No. DE 10 2009 041 337.5 entitled “Bohrmaschinen-Werkzeug”, filed Sep. 15, 2009.

### FIELD OF THE INVENTION

The present invention generally relates to a drilling machine tool used for at least partially removing a coating or a layer of a base body of a tube.

### BACKGROUND OF THE INVENTION

Tubes are provided with coatings. In the case of a tube made of iron, a coating might be provided for a protection of the tube against corrugation or transport damages. In case that an axial section of the outer surface of the tube serves as a functional surface, the coating is not suitable for building the functional surface. This is due to the material properties, pores, protrusions, openings, inhomogeneities, stiffness, hardness and other properties of common coating materials. Furthermore, in some cases it is not possible to keep an outer diameter or roundness of the outer surface within given tolerances. When coating the tube by dipping the tube into a fluid, e.g. a lacquer or enamel, the outer diameters of the outer surface of the coating as well as the roundness of the outer surface vary in an extent making the coating unsuitable for building a functional surface. Furthermore, the coating might comprise hardened drops, scratches or cracks. In case that the functional surface of the tube or the coating is used as a contact surface for a sealing element, the aforementioned defects of the functional surface might lead to a leakage between the sealing element and the functional surface and/or increased wear.

EP 1 797 982 A1 relates to a tool with a blade. The position of the blade is adjusted to the dimensions of the work piece prior to the use of the tool. In use the tool is stationary held by the user and pressed against a rotating tube.

U.S. Pat. No. 5,733,074 A relates to a manual tool for removing material from brittle or non-ductile stock. The front surface of the tool is equipped with cutting members. The user presses the drilling machine with the attached drilling machine tool in axial direction against a wall such that the cutting members cut in axial direction into the wall. Additional ultrasonic torsion vibrations increase the efficiency of the drilling machine tool. The drilling machine tool is used in the construction industry for the installation of various electrical and mechanical equipment to work on the construction material, such as concrete, with or without reinforcing steel, wood, masonry and also metal for removing material to prepare openings or channels for various equipment and fittings or recesses or depressions for plug-in sockets.

### SUMMARY OF THE INVENTION

The present invention relates to a tool for providing an improved functional surface of a tube. In particular, the invention provides a simple procedure for at least partially removing a coating or layer of a base body of a tube. One object of the invention is to provide a design of the tool leading to low costs.

According to one embodiment of the invention, the invention suggests using a drilling machine for at least partially removing the coating or layer instead of using a tool moved by zo hand as disclosed in EP 1 797 982. In the sense of the present invention, a “drilling machine tool” is any tool that is driven by a drilling machine of any type for a rotational movement. To name only some examples, the drilling machine tool might be coupled with a hand drill, a cordless hand drill or cordless screwdriver. Accordingly, the inventive drilling machine tool provides the option of using a drilling machine of any type in a multifunctional way, i.e. for its usual purposes as well as for driving the inventive drilling machine tool.

The inventive drilling machine tool is equipped with a blade. For a tool not covered by the present invention, a coating or layer is removed by a grinding process, wherein a grinding body is pressed with a contact surface against the outer surface of the coating or layer. For these grinding processes, after a short operating time ground particles of the coating or layer close the valleys between the tips of the surface of the grinding body such that the grinding process becomes more and more ineffective. Furthermore, the tips and valleys of the surface of the grinding body might smooth out during the grinding process. Instead, according to the invention, a cutting process is used. The efficiency of the blade is in general not deteriorated by the removed particles. The design of the cutting edge of the blade, the choice of the material of the blade and any possible hardening processes for the cutting edge of the blade as well as the geometry of the cutting blade might be chosen for guaranteeing a long lifetime of the blade making the blade suitable for a large number of operations. However, the invention also covers embodiments where both a blade as well as other elements as grinding elements are used.

It is possible to displace the cutting edge in radial inner direction towards the rotational axis of the drilling machine tool (and towards the longitudinal axis of the tube). An activation element biases the blade versus the rotational axis, so versus the outer surface of the tube. The activation element along the degree of freedom of the blade in radial inner direction causes a cutting force between the cutting edge of the blade and the outer surface of the tube or the layer of the coating. When driving the drilling machine tool by the drilling machine for a rotational movement, the cutting edge is moved relatively to the tube in circumferential direction of the tube.

The cutting edge is designed, configured and orientated such that the cutting edge preferably does not contact the outer surface of the tube at one single discrete contact point but with an extended extension at the outer surface of the tube. In some cases, the axial extension of the contact of the cutting edge with the tube corresponds to the desired axial extension of the functional surface to be produced.

To say it in simplified words, the working method of the inventive drilling machine tool might be described as a peeling tool. The “peeling” effect of the drilling machine tool does not necessarily lead to one integral chip but might lead to a plurality of chips or also smaller cut particles.

For the orientation of the cutting blade and the cutting edge in a cross-section transverse to the rotational axis the following applies: In a first extreme orientation the blade might have an orientation in radial direction. In the opposite extreme position, the cutting blade in the mentioned cross-section might have an orientation in circumferential direction of the tube. For this extreme orientation, the cutting movement of the blade might—in a simplified explanation—be seen similar to the peeling of an apple or potato. Any angular orientation of the blade and the cutting edge between the aforementioned extreme orientations is also covered by the present invention.

For one embodiment of the invention, due to the cutting force caused by the actuating element at the beginning of the working process when the drilling machine tool is still at rest the blade enters into the coating or layer of the tube. With the rotation of the drilling machine tool by the drilling machine, the cutting depth of the blade does not change significantly. However, in a preferred embodiment during the rotational movement the blade cuts deeper and deeper into the coating or layer of the tube such that the route of the cutting edge builds a spiral when seen in a cross-section of the tube.

In the present application, orientations as “parallel”, “in radial inner direction” and “in circumferential direction” both cover exact orientations or deviations from these orientations of up to 1°, 2°, 5° or also 10°.

According to another embodiment of the invention, the cutting edge has an orientation parallel to the rotational axis of the drilling machine tool. Such orientation has the effect that the cutting edge builds a straight contact line with the outer surface of the tube. The longitudinal contour of the cutting edge corresponds to the manufactured contour of the functional surface: in case of a straight cutting edge the functional surface is cylindrical. In case of using any differing contour of the cutting edge in longitudinal direction, e.g. convex or concave cutting edge contours, any differing shapes of the functional surface might be manufactured.

Any type of activation element for biasing the blade in radial inner direction might be used for the present invention. To name only some examples, the drilling machine tool might comprise an eccentric weight located distant from the rotational axis. The rotation of the drilling machine tool causes an inertial force acting upon the inertial mass of the eccentric weight. This force might be transferred to the blade via a suitable transmission or transfer mechanism leading to an activation force and cutting force. This cutting force might be dependent on the rotational velocity of the drilling machine tool. Accordingly, by controlling the driving velocity of the drilling machine it is possible to adapt the cutting force and the manufacturing characteristics of the drilling machine tool. Another example for an activation element that might be used for the present invention is an activation element manually adjusted to a desired cutting force by use of an adjusting element that might change the position of one end of a biasing spring. For a very simple embodiment of the invention, the cutting force is a produced by a spring element, e.g. a leave spring, an elastomer spring or a spiral or compression spring. Besides the low costs of such spring elements, this embodiment leads to a reproducible cutting force that is not or only to a small extent dependent on the rotational velocity of the drilling machine tool. Furthermore, the use of a spring element leads to the advantage that the use of the drilling machine tool is not necessarily restricted to tubes with an outer diameter within a small tolerance band. Instead, the spring element allows an automatic adaptation to differing outer diameters of the tube. Here, the spring element allows an adjusting movement of the blade for differing tube diameters but guarantees a cutting force within a defined cutting force range which is dependent on the chosen spring characteristic. For the spring characteristic and the chosen cutting force there are a lot of different options. In case of the coating to be removed being enamel or lacquer, a spring element might be chosen having a stiffness and design leading to a cutting force in the range from 10 to 80 N, in particular 20 to 50 N or 25 to 40 N for each centimeter length of the cutting edge.

The inventive drilling machine tool comprises a guiding element for aligning the base body of the drilling machine tool with the tube and for defining a rotational axis for a rotational movement of the base body around the tube. The guiding element guarantees a functional surface which is rotationally symmetrical to the longitudinal axis of the tube.

For the guiding element, a plurality of embodiments exist. To name only one example, the guiding element might be built with at least one supporting body supporting the tube at its inner and/or outer surface. It is possible that the supporting body provides a supporting force with at least one supporting force component having an orientation opposite to the cutting force applied by the blade on the tube. In case of a blade in a drilling machine tool interacting with the outer surface of the tube at a 12-o'clock-position, one supporting body might be positioned in the 6-o'clock-position or two supporting bodies might be positioned in a 4-o'clock-position and an 8-o'clock-position leading to symmetrical forces. The person with skill in the art will know that also a differing number of blades and/or supporting bodies might be used with differing positions and orientations.

For one embodiment of the invention, the supporting body comprises a rough surface contacting the tube. The rough surface might lead to a roughening effect of the outer surface of the tube for easing the subsequent cutting process of the blade. However, it is also possible that the supporting body comprises a smooth outer surface.

For one embodiment, the supporting body builds a sliding contact with the outer surface of the tube which might also strengthen the aforementioned roughening effect or also lead to a kind of additional grinding effect.

For another embodiment of the invention, it is suggested to use at least one rotatable cylindrical supporting body. With a rotational movement of the drilling machine tool, the supporting body builds a rolling contact with the outer surface of the tube leading to a good guidance between the drilling machine tool and the tube.

For another embodiment of the invention, the drilling machine tool comprises at least one chamber for receiving material removed by the cutting edge. The chamber housing the removed particles guarantees that the function of the drilling machine tool is not deteriorated by cut particles during the working process of one single tube or subsequent working processes of a plurality of tubes.

Furthermore, it is possible that the particles removed from the tube are removed from the chamber of the drilling machine tool after a given number of working processes or only in cases that the chamber is sufficiently filled. It is possible to remove the material from the chamber by knocking the tool against another body, by blowing the receiving chamber with pressurized air and the like. Furthermore, it is possible that at least one removing channel extends from the receiving chamber for removing material or particles during or subsequently to the working process from the drilling machine tool. Furthermore, it is possible that the removal and/or an airstream for the removal of the material or particles through those channels might be automatically caused by the rotation of the drilling machine tool. For these embodiments, the outer surface of the drilling machine tool or the base body of the same might be equipped with suitable openings and/or wings for guiding and causing the desired airstream.

In case that it is desired to produce a functional surface with a given distance from a front surface of the tube, the invention suggests equipping the drilling machine tool with an end stop. The end stop defines the end position when introducing the tube into the drilling machine tool.

For another embodiment of the invention, the drilling machine tool is multifunctional such that it is not only designated for removing a coating or layer of the tube. For one embodiment, the invention suggests providing at least one burr removing element for removing burrs from the front surface of the tube, in particular from an inner and/or outer edge of the tube. The burr removing element is rotated by the drilling machine relative to the tube might. For this embodiment, it is e.g. possible to use tubes that have been cut by a chop saw, a band saw, a tube cutter or other imprecise tools, wherein the caused burrs or bulges are removed by the burr removing element.

It is also possible that due to an imprecise cutting process of the tube, the front surface of the tube does not have an orientation transverse to the longitudinal axis of the tube. In such case the invention suggests a drilling machine tool, wherein the burr removing element is resiliently supported at the front surface of the tube for allowing an adjusting movement of the burr removing element during the rotation of the drilling machine tool relatively to the tube.

In case of using one and the same drilling machine tool for working tubes of two zo differing diameters, it is possible to provide the drilling machine tool with an adjusting element. For one embodiment, the adjusting element changes the distance of the blade (and the spring element) from the rotational axis of the drilling machine tool. It is also possible that the adaptation to differing tube diameters is done by an exchange of the blade and by using blades having differing dimensions. Furthermore, it is possible to use one and the same blade and spring element for differing tube diameters but to use differing guiding elements or supporting bodies for working differing tube diameters.

Prior to starting the drive movement of the drilling machine the tube is introduced into the drilling machine tool. During this introducing movement, it might be of advantage that the bade is not biased in radial inner direction which leads to a longitudinal cut of the blade in axial direction into the coating or layer. By suitable measures, e.g. a resting or locking device, the blade might be held in a position distant from the tube throughout the introducing phase. The locking or resting unit is unlocked at the end of the introducing phase which might be done manually or automatically when reaching the end position or end stop or a trigger for unlocking. In case of the blade already being biased by the cutting force when introducing the tube into the drilling machine tool, the cutting blade might be equipped with a lead-in chamfer. At the start of the introducing process, the blade is pushed by the activation element in the innermost radial position. Accordingly, at the start of the introducing process of the tube into the drilling machine tool, the front surface of the tube comes into contact with the lead-in chamfer. By pressing the tube into the drilling machine tool, the front surface slides along the lead-in chamfer and pushes the blade in radial outer direction. This movement of the blade in radial outer direction might increase the bias of the spring element supporting the blade against the base body of the drilling machine tool.

For the coupling of the drilling machine tool with a drive of the drilling machine, there are a lot of different possibilities. For a very simple embodiment, a coupling element with a polygonal cross-section, in particular a hexagonal cross-section is used that might be coupled with known drill chucks of an accumulator-powered hand drill or any other drive unit.

For another embodiment of the invention, the blade is exchangeable. In case of wear of the blade leading to a decrease of the efficiency of the drilling machine tool or a deterioration of the produced functional service, the blade is exchanged. It is also possible that the blade is exchanged for adapting the drilling machine tool to different tube diameters, for manufacturing functional surfaces with differing contours and the like.

Any type of cutting edge might be used, wherein any cross-sectional contour of the cutting edge, any material and any hardening process might be used. For one embodiment of the invention, a broken cutting edge is used leading to an increased lifetime of the cutting blade.

For one embodiment of the invention, only one blade interacts with the outer surface of the tube. However, it is also possible that a plurality of cutting blades is used, wherein the cutting blades are positioned at differing axial regions and/or circumferential positions. The cutting blades might be equipped with the same or differing cutting edges and might be pressed against the tube with the same or differing cutting forces. It is also possible that only one of the plurality of blades is selectively activated for the working process of tubes having a diameter in a special range of diameters.

For increasing the operational safety of the drilling machine tool, a sliding clutch or security clutch might be integrated into the drilling machine tool. In case of the blade interlocking with the tube during the working process, the sliding or safety clutch might separate the drive train from the drilling machine to the tool for avoiding unsafe operational states or impulse-like forces acting on the hand of the user.

The housing of the drilling machine tool might be built from any known material, e.g. metal. One embodiment of the invention suggests using a housing of the drilling machine zo tool being partially or completely built from a plastic material which reduces the costs and the rotating weight. Furthermore, any known manufacturing process for building a housing from a plastic material, in particular injection molding, might be used. Furthermore, the use of plastic leads to a plurality of options for the design and shape of the housing.

The inventive drilling machine tool in particular will be used for at least partially removing a coating or layer of a tube for providing a functional surface for a sealing element.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a longitudinal section of a tube which has been worked with an inventive drilling machine tool.

FIG. 2 shows a three-dimensional explosional view of a drilling machine tool.

FIG. 3 is a plan view of the drilling machine tool of FIG. 2 in an assembled state.

FIG. 4 is the drilling machine tool of FIGS. 2 and 3 in a front view.

FIG. 5 is the drilling machine tool of FIGS. 2 to 4 in a three-dimensional view.

FIG. 6 is the drilling machine tool of FIGS. 2 to 5 in a view similar to FIG. 5, wherein hidden edges are indicated by dashed lines.

FIG. 7 shows a schematic presentation of the interaction of the cutting blade having a broken cutting edge with the outer surface of a tube in a drilling machine tool.

FIG. 8 shows a schematic representation of the interaction of a cutting blade not having a broken cutting edge with the outer surface of a tube in a drilling machine tool.

### DETAILED DESCRIPTION

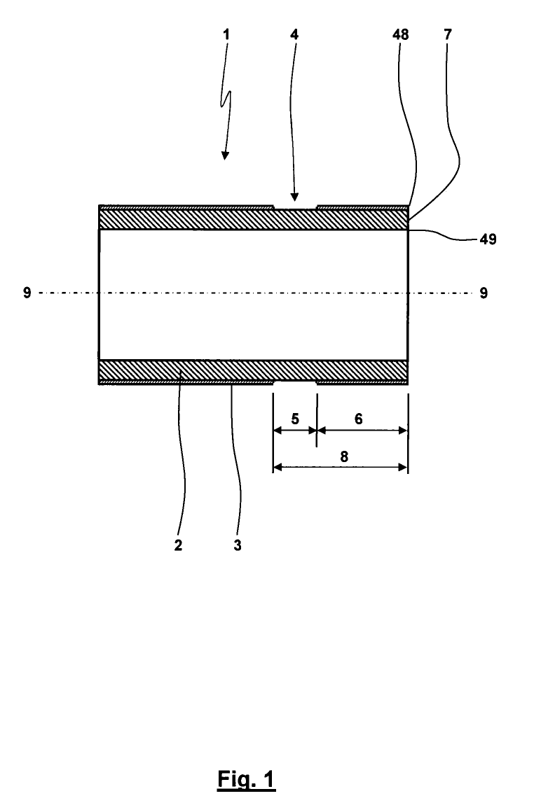

Referring now in greater detail to the drawings, FIG. 1 illustrates a tube 1. The tube 1 comprises a hollow cylindrical base body 2, e.g. a tube section made of metal. the base body is at least in an end region covered by a coating 3. The coating 3 extends over the outer surface 51 of the base body 2. Prior to the use of the inventive drilling machine tool, the coating 3 extends over the entire outer surface of the base body 2. The inventive drilling machine tool is used for providing a functional surface 4 building the contact surface for a sealing element. Accordingly, the functional surface 4 is required to fulfill given requirements with respect to diameter, surface roughness and roundness. The functional surface 4 should have a given and constant axial extension 5, a given distance 6 from a front surface 7 of tube 1 and should end at a distance 8 from the front surface 7. The tube 1 comprises a longitudinal axis 9-9. As a possible result of the use of the inventive drilling machine tool, in FIG. 1 the coating 3 in the region of the functional surface 4 is completely removed so that the original outer surface of the base body 2 is recovered. However, it is also possible that with the use of the drilling machine tool the coating is not completely removed in the region of the functional surface 4. Accordingly, the drilling machine tool only reduces the thickness of the layer of the coating in the region of the functional surface 4. However, it is also possible that the blade of the drilling machine tool first completely removes the coating and subsequently cuts into the material of the base body 2. In case of the base body 2 having a rough surface, it is possible that the inventive drilling machine tool 10 removes tips or mountains of the surface of the base body 2 but keeps material of the coating in the valleys of the base body 2. In such case, the produced functional surface 4 is partially built by material of the base body 2 and partially built by material of the coating 3. The coating 3 might be made from any known material, in particular an enamel or lacquer. It is also possible that the drilling machine tool 10 is used for a tube without an additional coating. In this case the tube 1 is built from one single material, e.g. the tube is a tube section made of metal. For this application of the drilling machine tool, the drilling machine tool 10 only removes material from the base body 2 for manufacturing the functional surface which in the present application is also named “removal of a layer”.

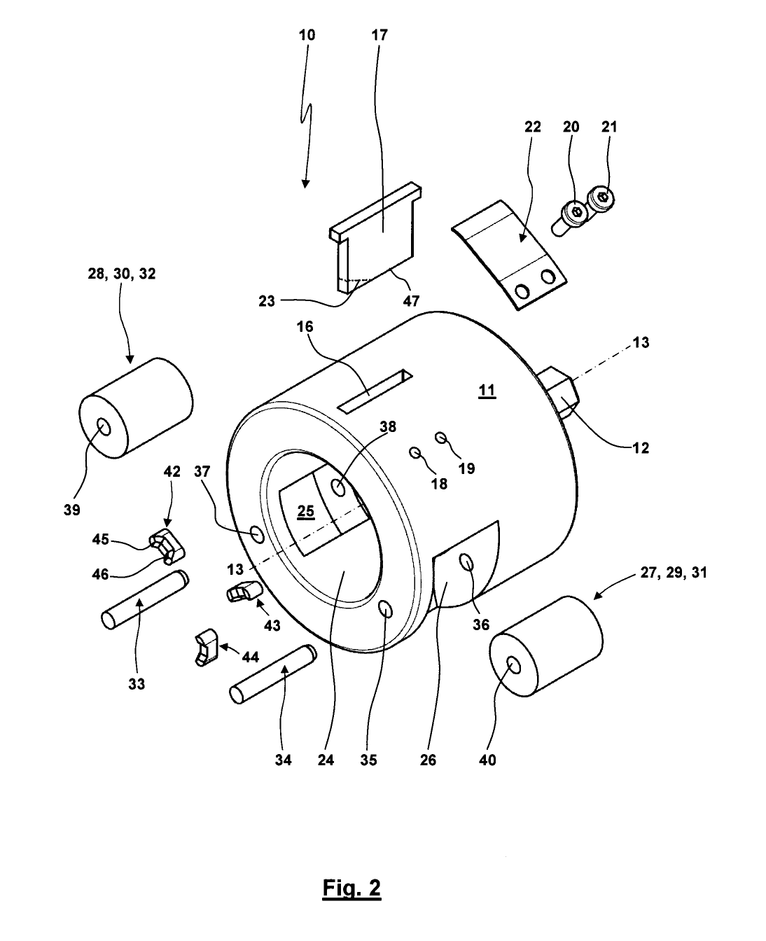

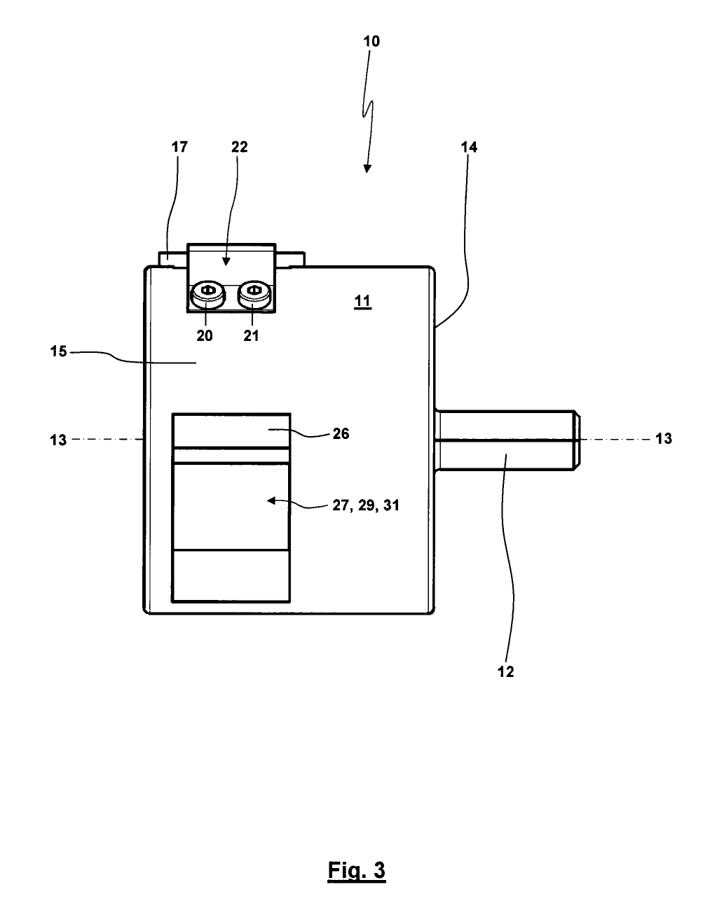

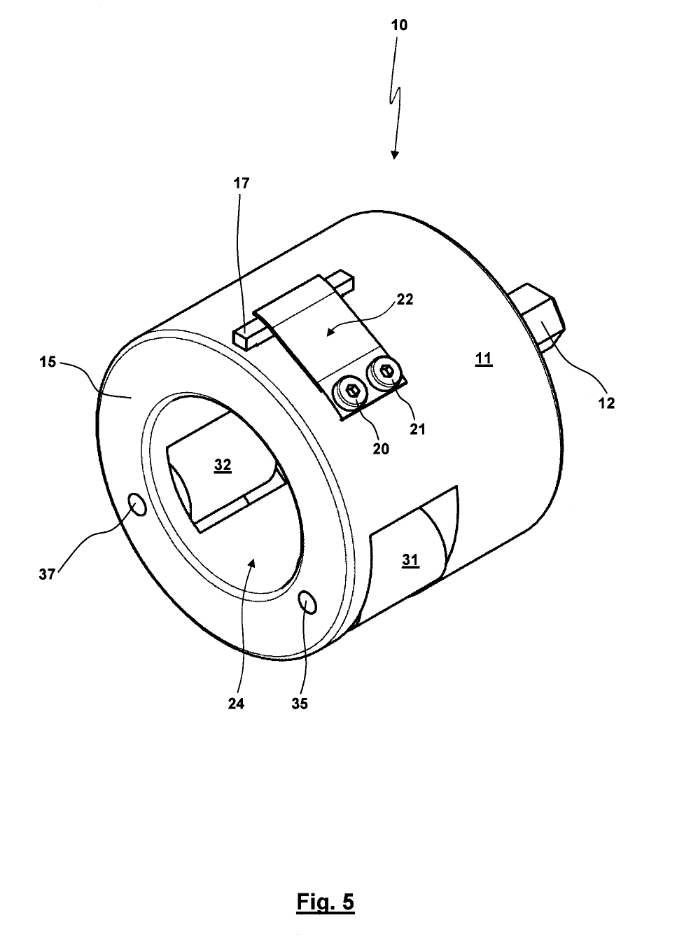

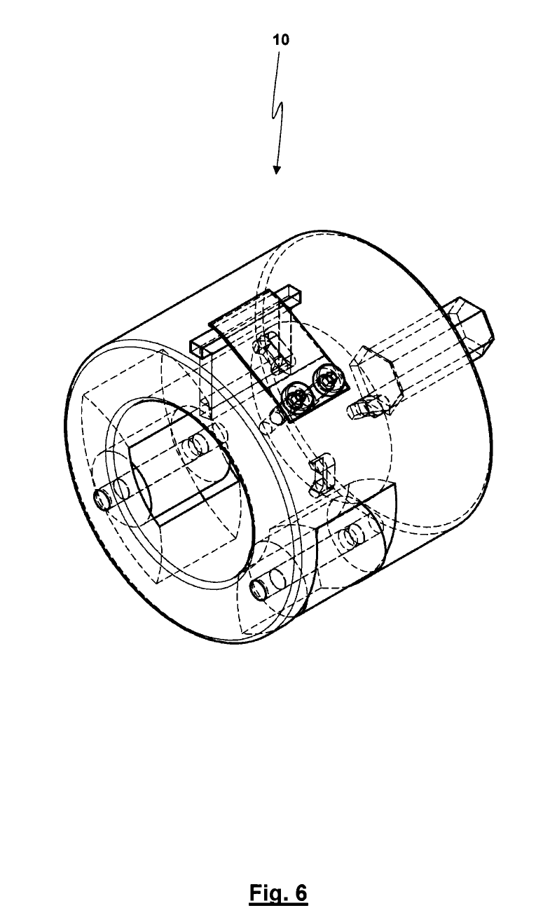

FIG. 2 shows a drilling machine tool 10 in a three-dimensional explosional view, whereas FIGS. 3 to 6 show this drilling machine tool 10 in different views in an assembled state.

The drilling machine tool 10 comprises a housing 11. The housing 11 comprises a protrusion building a drive element. For the shown embodiment, the drive element is a protrusion with a hexagonal cross-section. This protrusion is coupled with the chuck of a drilling machine. The protrusion 12 defines a longitudinal and rotational axis 13. The housing 11 has in a first approximation a pot-like shape with a U-shaped longitudinal section, wherein the parallel side legs of the U are symmetrical to the longitudinal axis 13-13 and the base leg of the U has an orientation transverse to the longitudinal axis 13-13. The base leg of the U builds a disc-like base plate 14, whereas the side legs build a hollow cylindrical wall 15 of the housing 11.

As can be seen from FIG. 2, wall 15 comprises a through-opening or recess 16 extending in radial direction. A cutting blade 17 is inserted in radial inner direction into recess 16. The cutting blade 17 is guided by recess 16 in radial inner direction, whereas the axial position of the blade 17 is fixed by the recess 16 (with some play for allowing the required movement in radial direction). For the shown embodiment, recess 16 has a slot-like shape with a rectangular cross-section which is closed in circumferential direction. The blade 17 is in a first approximation T-shaped. The cross-section of the vertical leg of the T corresponds to the cross-section of recess 16, wherein a gap or some play is built between the vertical leg of the T and the recess 16 for providing a sliding degree of freedom of the blade 17 relative to the wall 15 but also the desired guidance in radial direction. The extension of the transverse leg of the T is larger than that of recess 16 so that the transverse leg of the T in the radial inner end position of the blade 17 in the recess 16 abuts the outer surface of wall 15. This radial inner end position defines the closest position of the cutting blade 17 from the rotational axis 13-13. Adjacent the recess 16 when seen in circumferential direction, the housing 11 comprises threaded bores 18, 19. An elastic sheet metal 22 is mounted with the housing 11 by screws 20, 21 screwed into the threaded bores 18, 19. In the end region opposite to the screws 20, 21, the pre-biased elastic sheet metal is mounted with the transverse leg of the T of the cutting blade 17. The elastic sheet metal 22 biases blade 17 in radial inner direction for producing a cutting force. The cutting blade 17 as well as recess 16 have an orientation parallel to the rotational axis 13-13 (see FIG. 2). The cutting blade 17 might also be equipped with a lead-in chamfer 23, see the dashed lines in FIG. 2.

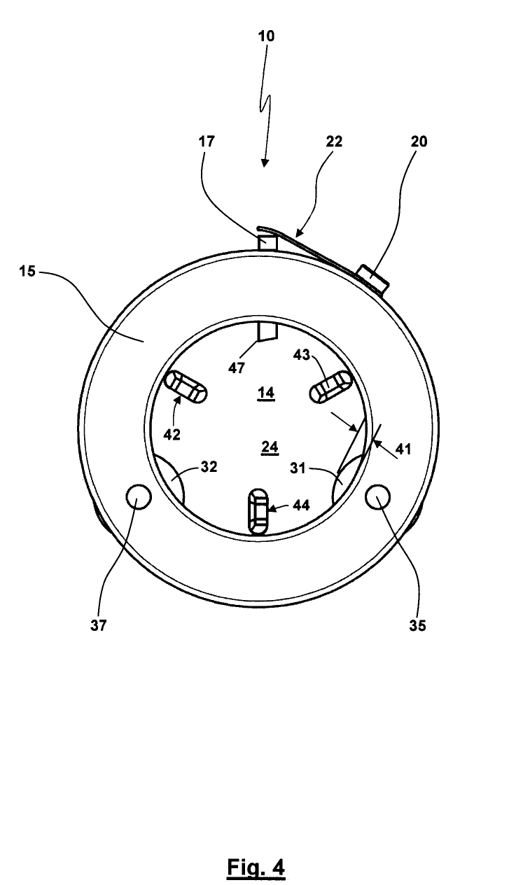

The housing 11 builds a chamber 24 having one open end for receiving tube 1. Chamber 24 is defined in radial outer direction by wall 15 and in axial direction by base plate 14. The wall 15 comprises openings 25, 26 being closed in circumferential direction and communicating with chamber 24. Guiding elements 27, 28 are received in recesses 25, 26. For the shown embodiment, the guiding elements 27, 28 build supporting bodies 29, 30, here rotatable rolls 31, 32. The rolls 31, 32 or cylindrical supporting bodies are borne by bolts 33, 34 for a rotating movement. The bolts 33, 34 have an orientation parallel to the longitudinal axis 13-13 and extend through the openings 25, 26. The bolts 33, 34 are housed with their end regions in bores 35, 36; 37, 38. The bolts 33, 34 extend through the longitudinal bores 39, 40 of the rolls or cylinders 31, 32. As can be seen from FIG. 4, the rolls or cylinders 31, 32 protrude from the inner surface of wall 15 with a distance 41 in radial inner direction versus longitudinal axis 13-13.

FIG. 2 shows three burr removing elements 42, 43, 44. The burr removing elements 42, 43, 44 are V-shaped or U-shaped in a first approximation, wherein for the U-shape the lateral legs are not parallel but opening with increasing distance from the base leg of the U. The lateral legs of the V or U build cutting elements 45, 46. The burr removing elements 42, 43, 44 are positioned at a cycle having a diameter corresponding to the diameter of the tube and are positioned equidistant when seen in circumferential direction. The burr removing elements 42, 43, 44 are mounted with the base plate 14 or are supported by base plate 14 with interposed spring elements having an elasticity along the longitudinal axis 13-13.

For a use of the drilling machine tool 10, the drilling machine tool 10 is coupled with its hexagonal cross-section 12 with a chuck of a drilling machine. Subsequently, the tube to be worked is introduced into the receiving chamber 24 of the drilling machine tool 10. For the shown embodiment, the cutting blade 12 is positioned in a 12-o'clock-position in a cross-section of the drilling machine tool, whereas the guiding elements 27, 28 are positioned in a 4-o'clock-position and an 8-o'clock-position. During the introducing process of the tube 1 into the receiving chamber 24, the outer surface 51 of the tube slides in axial direction along the outer surface of the rolls or cylinders 31, 32 without any rolling movement of the rolls 31, 32 along the outer surface 51 of the tube. However, the contact of the outer surface 51 of the tube 1 with the rolls 31, 32 determines the distance of the outer surface 51 of the tube 1 from wall 15. For a contact of the surface 51 of the tube 1 with the two rolls 31, 32, the longitudinal axis 13-13 of the drilling machine tool 10 and the longitudinal axis 9-9 of the tube 1 are aligned with each other. At the beginning of the introducing process of tube 1 into the receiving chamber 24, the cutting plate 17 due to the activation of the elastic sheet metal is in the radial innermost position. The front surface 7 of the tube 1 comes into contact with the lead-in chamfer 23 of the cutting blade 17. Further movement of tube 1 displaces the front surface 7 of the cutting blade 17 in radial outer direction. At the end of this radial movement of the cutting blade 17, the cutting edge 47 of cutting blade 17 slides along the outer surface 51 of tube 1. An end position of tube 1 is reached when the front surface 7 of the tube 1 abuts at base plate 14 or an end stop mounted with the base plate 14. For the shown embodiment, the end stop is built by the burr removing elements 42-44. The cutting edges 45 interact with the outer edge 48 at the front surface 7 of tube 1, whereas the cutting edges 46 interact with the inner edge 49 of the front surface of tube 1. Further pressing of tube 1 inside the drilling machine tool 10 increases the contact force between the outer edge 48 and inner edge 49 with the cutting edges 45, 46. Now the drilling machine tool 10 is driven by the drive or drilling machine. During this driven movement, tube 1 is manually fixed or fixed by an additional holding device. The driven movement of the drilling machine tool 10 results in the following manufacturing processes:
a) The cutting edges 45, 46 remove the burrs at the outer edge 48 and the inner edge 49 of tube 1. Here, the axial pressing force applied by the user upon the drilling machine and the drilling machine tool 10 influences the burr removing effect and determine the cutting force at the burr removing elements.
b) The outer surface 51 of tube 1 is moved relatively to cutting edge 47 in circumferential direction around the rotational axis 13-13. During this relative movement, the cutting edge 47 is pressed by the cutting force caused by the activation element against the outer surface 51 of tube 1. This movement and the cutting force lead to a removal of parts of the coating 3 or a “peeling” or “scratching” effect.
c) During the driven movement, the rolls 31, 32 roll along the outer surface 51 of tube 1. In case of the rolls 31, 32 having a smooth surface, this rolling movement does not lead to a significant working process at the surface 51 of the tube 1. However, it is also possible that the outer surface of the rolls 31, 32 are not smooth but rough, comprising grooves or tips and valleys. For these embodiments, the outer surface 51 of tube 1 is worked throughout the rolling movement, which might be done for preparing the cutting movement of the cutting edge 47 according to b).

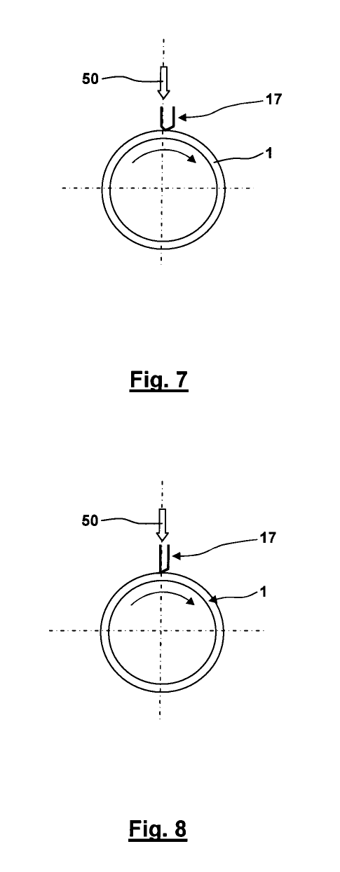

FIGS. 7 and 8 schematically show the relative movement between tube 1 and cutting blade 17 in circumferential direction. According to FIG. 7, a cutting blade 17 is used having a broken cutting edge 47, whereas in FIG. 8 a non-broken cutting edge is used. The plane of the main extension of the cutting blade 17 according to FIGS. 7 and 8 has an orientation radial to the longitudinal axes 9-9, 13-13 as well as parallel to the longitudinal axes. Furthermore, in FIGS. 7 and 8 the cutting force 50 having an orientation in radial direction is shown.

Due to the support of the cutting blade 17 by the elastic sheet metal 22, it is possible to adapt the blade position to varying tube diameters. For one example, the cutting blade 17 and the elastic sheet metal 22 are designed such that differing diameters of the coating 3 up to 1.5 mm in difference might be adapted.

In the figures, an embodiment with one single blade 17 and two guiding elements 27, 28 is shown. However, the invention might be embodied with any differing number of cutting blades 17 and/or guiding elements 27, 28. For centering and aligning the longitudinal axes 9-9, 13-13, any differing centering and/or guiding devices might also be used. To name only one example, the drilling machine tool 10 might be equipped with a mandrel entering into tube 1. It is also possible that guiding elements, supporting bodies or rolls are supported at the inner surface of the tube 1.

In wall 15 close to the cutting blade 17 cavities, bores, recesses having an orientation in radial outer direction might be provided that build receiving chambers for particles separated by the cutting blade 17 from the tube.

Many variations and modifications may be made to the preferred embodiments of the invention without departing substantially from the spirit and principles of the invention. All such modifications and variations are intended to be included herein within the scope of the present invention, as defined by the following claims.

We claim:

1. A drilling machine tool for at least partially removing a coating or an outer layer of a tube, comprising:
a base body,
at least one guiding element for aligning said base body with the tube and for defining a rotational axis for a rotational movement of said base body around the tube,
at least one blade comprising a cutting edge, said blade being linked with said base body with a degree of freedom having at least a component in a direction radial to the rotational axis,
an activation element biasing said blade in radial inner direction.

2. The drilling machine tool of claim 1, wherein said cutting edge has an orientation parallel to the rotational axis.

3. The drilling machine tool of claim 1, wherein said activation element is a spring element.

4. The drilling machine tool of claim 1, wherein at least one guiding element comprises a supporting body having a contact surface facing towards the rotational axis for supporting the tube in radial outward direction.

5. The drilling machine tool of claim 4, wherein at least one supporting body comprises a rough contact surface.

6. The drilling machine tool of claim 4, wherein at least one supporting body is rotatably linked with said base body and comprises a cylindrical outer surface for a rolling contact of said supporting body with the tube.

7. The drilling machine tool of claim 1, wherein at least one chamber is provided for receiving material or particles cut by said blade.

8. The drilling machine tool of claim 1, wherein an end stop is provided designed and positioned for abutting with a front surface of the tube when introduced into the drilling machine tool.

9. The drilling machine tool of claim 1, comprising at least one burr removing element designed and configured for removing burrs from a front surface of the tube.

10. The drilling machine tool of claim 1, comprising an adjusting unit for adjusting the distance of said blade from the rotational axis.

11. The drilling machine tool of claim 1, wherein said blade comprises a lead-in chamfer.

12. The drilling machine tool of claim 1, comprising a coupling element with a polygonal cross-section for coupling the drilling machine tool with a drilling machine.

13. The drilling machine tool of claim 1, wherein said blade is exchangeable.

14. The drilling machine tool of claim 1, wherein said blade comprises a broken cutting edge.

15. The drilling machine tool of claim 1, comprising a plurality of blades located at the circumference of the rotational axis.

16. The drilling machine tool of claim 1, comprising a sliding clutch or safety clutch.

17. The drilling machine tool of claim 1, wherein said base body is made of a plastic material.
